(19) United States
(12) Patent Application Publication
(10) Pub. No.: US 2017/0107586 A1
(43) Pub. Date: Apr. 20, 2017

(54) DEVICE AND METHOD FOR PLACING OR REMOVING A PELT BOARD

(71) Applicant: Eikon Technologies Holding S.à.r.l., Luxembourg (LU)

(72) Inventor: Kurt Pedersen, Vinderup (DK)

(21) Appl. No.: 15/128,752

(22) PCT Filed: Mar. 25, 2014
(86) PCT No.: PCT/EP2015/056440

§ 371 Date: Sep. 23, 2016

(30) Foreign Application Priority Data
Mar. 26, 2014 (DK) PA2014 70151

(51) Int. Cl. C14B 15/06; C14B 17/06

(52) U.S. Cl. CPC C14B 15/06; C14B 17/06

(57) ABSTRACT

A system (1) is disclosed comprising a machine (2) for stretching pelts on pelt boards (3) and a device (2) for placing the pelt boards (3) in the machine (2) and/or for removing the pelt boards (3) from the machine (2) after stretching of the pelts and fastening them to the pelt board (3). The invention further relates to the device (2) itself, and the methods for placing or removing a pelt board (3).

The invention relates to a system comprising a machine for stretching pelts on pelt boards and fastening the pelt to the pelt board, and a device for placing the pelt boards in the machine and/or for removing the pelt boards from the machine after stretching of the pelts and fastening them to the pelt board. The invention further relates to the device itself, and the methods for placing or removing a pelt board.

### BACKGROUND

Machines for stretching pelts and fastening the pelts on pelt boards are well known in the art and are disclosed e.g. in international patent application WO 02/44428, in WO 2005/028682 and in WO 2005/080607. It is an objective of the present invention to improve the efficiency of the process of stretching and fastening the pelts in order to improve the number of pelts that can be processed in this manner per hour by means of such machine.

### DESCRIPTION OF THE INVENTION

The pelt boards with the pelts arranged thereon are placed manually in the machine for stretching and fastening and are afterwards removed again manually and it has been realised by the present inventor that in particular an automated removal of the pelt board from the machine could improve the number of pelts to be processed by the machine as the operator, when the pelt board is removed from the machine, at the same time can handle a new pelt board by placing it in the machine which in any case requires manual handling for arranging the rim of the pelt in claws of the machine etc.

Thus, the present invention relates to a system comprising a machine for stretching pelts on pelt boards and a device for removing the pelt board from said machine, the device comprising a gripping arrangement for gripping a pelt board in an operational position at the machine, a displacement arrangement for displacing said gripping arrangement, and a controller for controlling the operation of said gripping arrangement and said displacement arrangement, the controller being adapted to perform a removal of a pelt board including the steps of
a) control the displacement arrangement to position the gripping arrangement ready for gripping a pelt board in an operational position at the machine,
b) control the gripping arrangement to grip said pelt board,
c) control the displacement arrangement to move the gripping arrangement carrying the pelt board upwards and in a horizontal direction, and
d) control the gripping arrangement to release the pelt board.

The operational position of the pelt board in the machine is the position in which the machine operates on a pelt arranged on the pelt board, i.e. stretches the pelt and fastens it to the pelt board.

By moving the pelt board upwards and also in a horizontal direction, the machine is cleared to receive another pelt board immediately without the system requiring excessive space in the vertical direction for its operation.

It is preferred that said horizontal movement of the gripping arrangement in step c) includes a movement towards a back side of the machine opposite an operator's place in front of the machine so that the pelt board is out of the way for the operator to place another pelt board in the machine, i.e. leaving free space to both left and right for the operator.

It is furthermore preferred that the controller is adapted to, between steps c) and d), perform the step of
c1) control the displacement arrangement to rotate the pelt board to a substantially horizontal position. Hereby, the pelt board can be released to a simple support arrangement such as the one shown in the example, to a conveyor belt or the like without requiring special arrangements for supporting the pelt board in an upright position.

In a particular embodiment, the device may also be used for loading or placing pelt boards into the machine, i.e. the controller may further being adapted to perform a placing of a pelt board in the machine, including the steps of
1) control the gripping arrangement to grip a pelt board ready for being processed by the machine,
2) control the displacement arrangement to move the gripping arrangement carrying the pelt board in a horizontal direction and downwards, so that the pelt board will be in an operational position in the machine, and
3) control the gripping arrangement to release the pelt board.

The pelt board is ready for being processed by the machine, i.e. to have a pelt stretched on the pelt board and fastened to it, which in a preferred embodiment includes that a pelt bag of a fat and moisture-absorbing material such as paper is arranged on the pelt board.

Said horizontal movement of the gripping arrangement in step 2) may in a preferred embodiment include a movement towards an operator's place in front of the machine.

In a particular embodiment of the system according to the present invention, the gripping arrangement comprises two sets of gripping elements and actuators for each set of gripping elements so that one set of gripping elements may handle a pelt board to be placed in the machine while the other set of gripping elements at the same time is removing a pelt board from the machine. It is furthermore preferred that one set of gripping elements are dedicated to placing a pelt board in said machine and the other set of gripping elements are dedicated to removing a pelt board from said machine.

The present invention also relates to a device for placing a pelt board in or removing a pelt board from a machine for stretching pelts on pelt boards or the device may be suitable for both operations, i.e. for placing and for removing a pelt board in and from a machine for stretching pelts, which device is suitable for constituting a part of a system according to the invention, i.e. for retrofitting to such machine.

The present invention furthermore relates to a method for removing a pelt board from a machine for stretching pelts on pelt boards by means of a device comprising a gripping arrangement and a displacement for displacing the gripping arrangement and to a method for placing a pelt board in an operational position at a machine for stretching pelts on pelt boards by means of a device comprising a gripping arrangement and a displacement for displacing the gripping arrangement. In particular, the methods are according to the present invention performed with mink pelts.

### BRIEF DESCRIPTION OF THE DRAWINGS

An example of the present invention is illustrated in the enclosed drawing of which the figures show consecutive steps of removing a pelt board from a machine for stretching pelts on a pelt board by means of a device for placing or removing the pelt board from the machine

FIG. 1 shows a starting position with a pelt board on position in the machine,

FIG. 2 shows the gripping elements of the device being situated next to the pelt board,

FIG. 3 shows where the gripping elements have made contact with the edges of the pelt board,

FIG. 4 shows the pelt board having been lifted up from the machine and moved towards the back of the machine opposite the operator's place in front of the machine,

FIG. 5 shows the pelt board being tilted to a horizontal position and placed in a support,

FIG. 6 shows the gripping elements released from the pelt board supported by the support,

FIG. 7, shows a displacement arrangement engaging the foot of the pelt board, and

FIG. 8 shows the pelt board displaced in the horizontal direction by means of the displacement arrangement.

### DESCRIPTION OF PREFERRED EMBODIMENTS

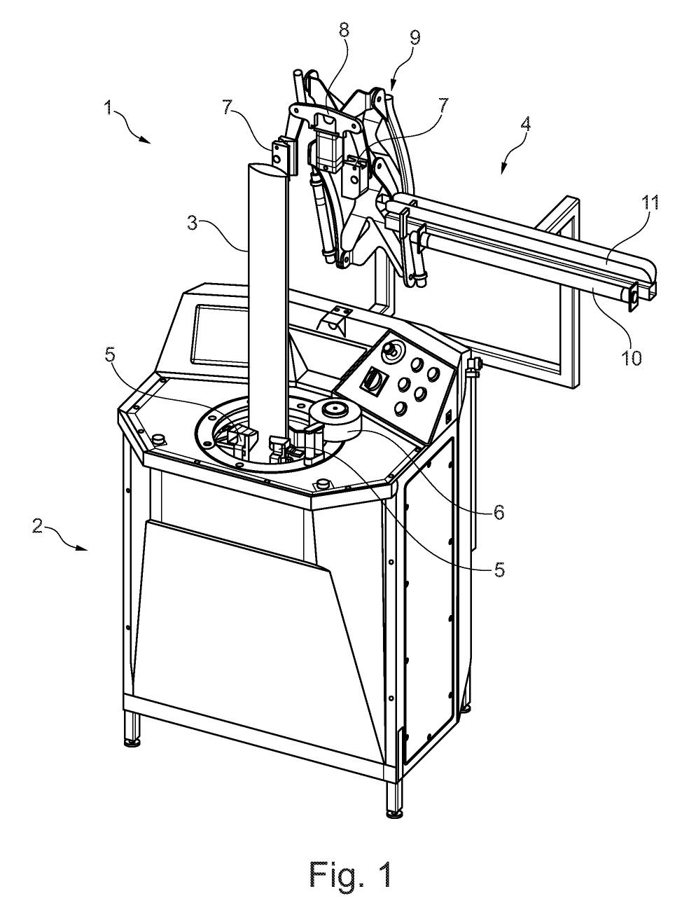

FIG. 1 shows a system 1 comprising a machine 2 for stretching pelts on a pelt board 3, of which the tip part is not shown, by means of a device 4 for placing or removing the pelt board 3 from the machine 2. The machine 2 is for illustrative purposes substantially identical to the one disclosed in international patent application No. WO 2005/080607 to 4M Globe Management but other known such machines may be employed as well. The machine 2 comprises a seat (not visible) for supporting the pelt board 3 in an upright position, claws 5 for gripping the pelt (not shown) arranged on the pelt board 3, forcing means (not shown) for stretching the pelt by a relative mutual movement in the vertical direction of the pelt and the pelt board 3, and fastening means 6 for securing the pelt to the pelt board 3 after stretching, in this case a roll 6 of a winding material to be wound around the lower part of the pelt.

The device 4 may in principle be operated for placing a pelt board 3 in the machine 2 as well as for removing the pelt board 3 from the machine 2. In the shown procedure, the pelt board 3 is removed from the machine 2 which is the preferred use of the device 4, i.e. after the pelt has been stretched on and secured to the pelt board 3. The device comprises as set of gripping elements 7 suited to engage the edges of the pelt board 3, which is of an ellipsoid or rectangular cross-section. The device 4 further comprises an actuator 8 for moving the set of gripping elements 7 to and from each other in order to grip and release the pelt board 3. A displacement arrangement 9 is provided for moving the set of gripping elements 7 and the actuator in the vertical direction, towards the back side of the machine 2 and for rotating the set of gripping elements 7 and the actuator substantially 90° as shown in the figures. The device also comprises a linear displacement arrangement 10 for displacing the pelt board 3 when it is supported in a horizontal position in the support 11 which is a rail with a groove.

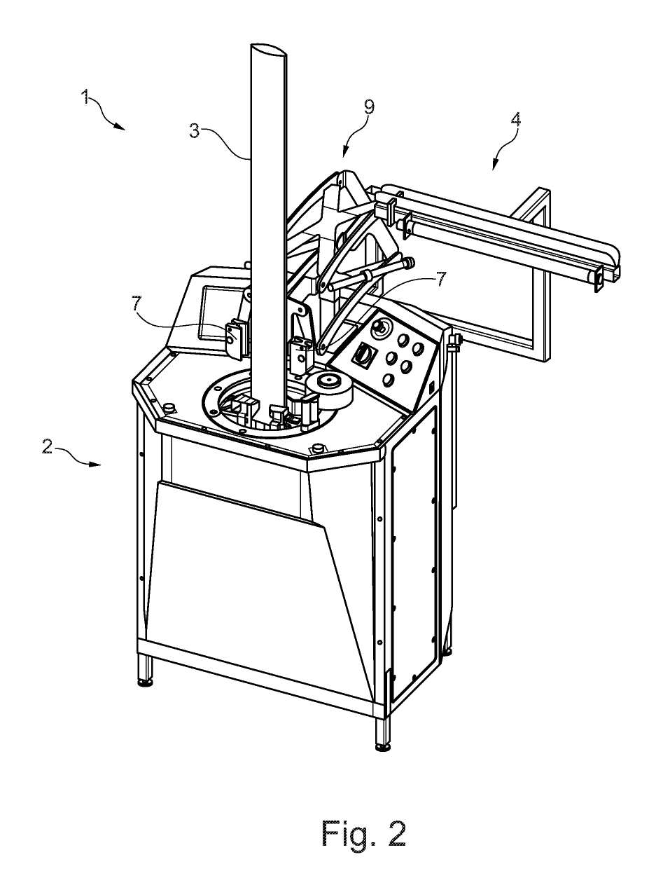

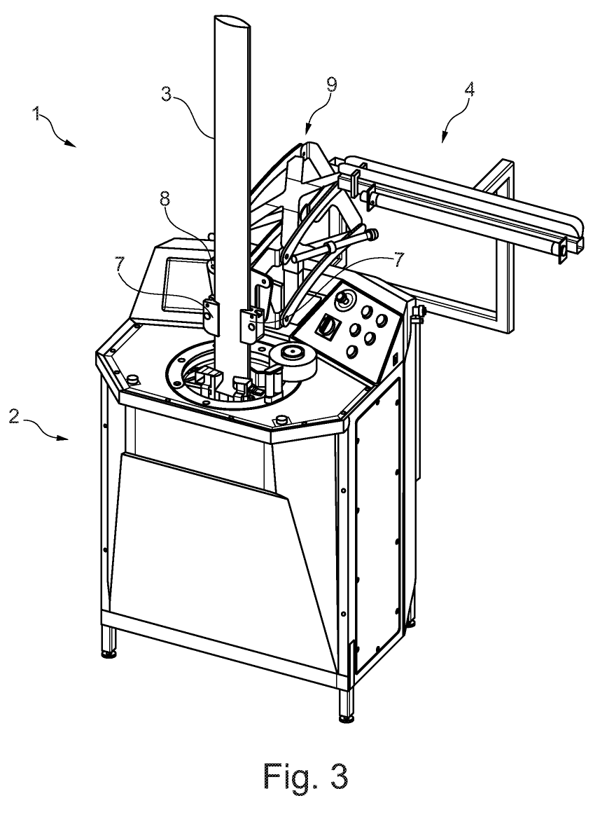

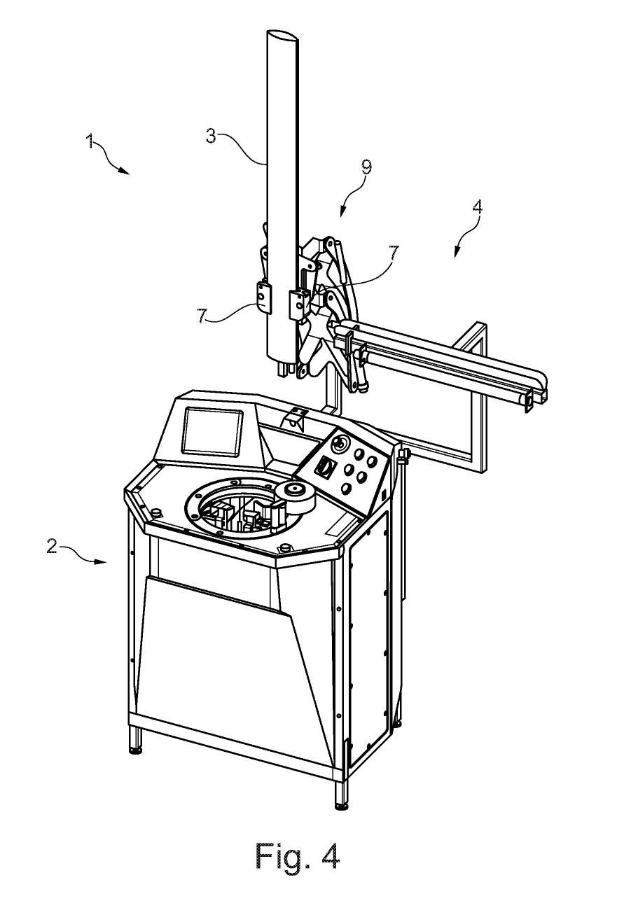

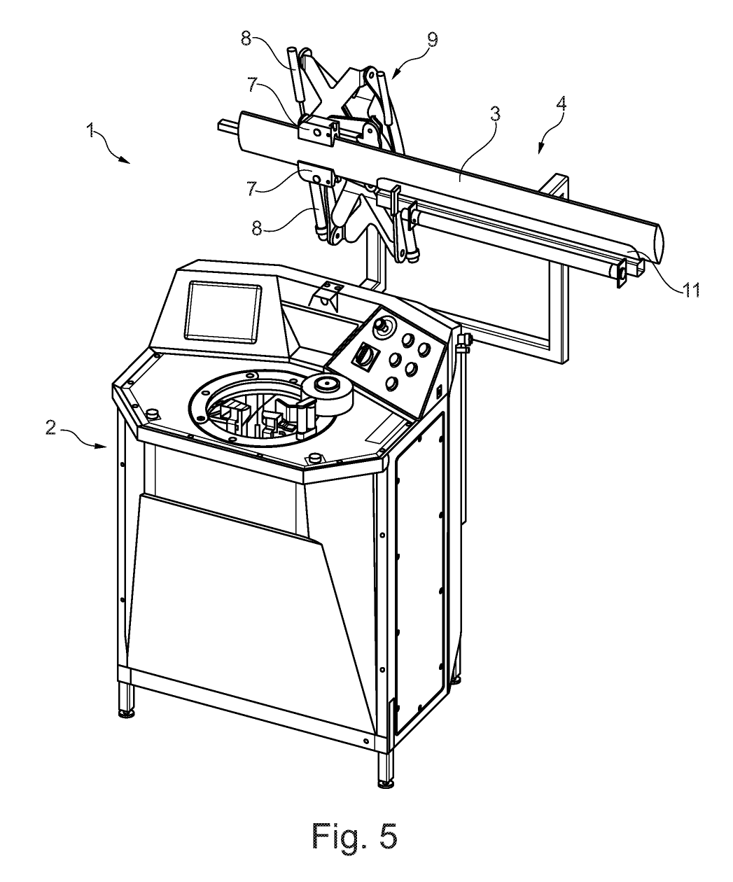

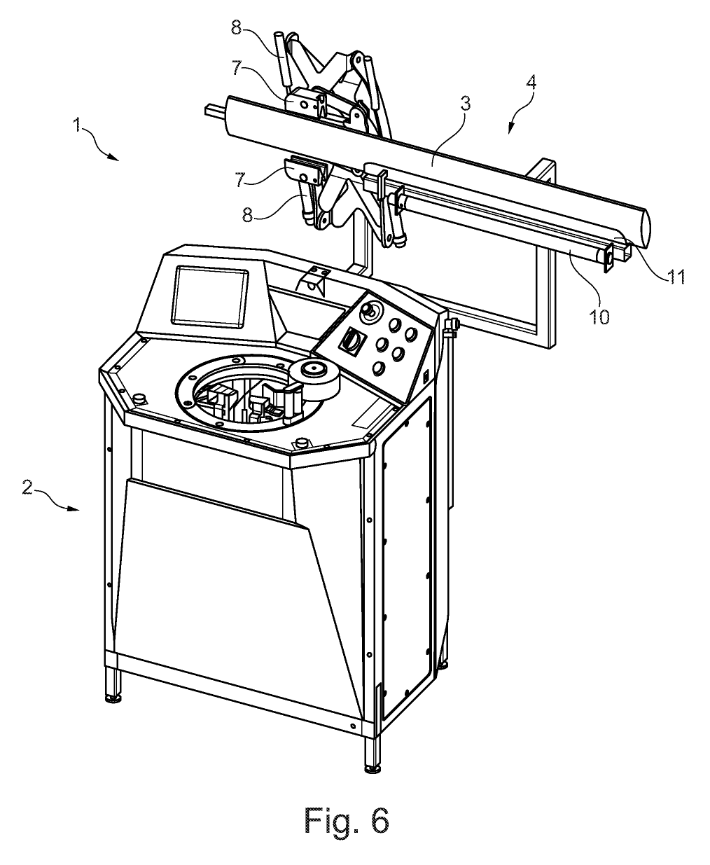

From the starting position in FIG. 1, the system is in FIG. 2 shows where the set of gripping elements 7 of the device 4 has being situated next to the pelt board 3 by means of the displacement arrangement 9, where after the actuator 8 causes the two gripping elements 7 towards each other until they have made contact with the edges of the pelt board 3 as shown in FIG. 3 and have a firm grip of the pelt board 3. Next, the displacement arrangement 9 moves the set of gripping elements 7 and the actuator 8 so that the pelt board 3 is lifted up from the machine 2 and moved towards the back of the machine 2 opposite the operator's place in front of the machine 2 as shown in FIG. 4. Then the displacement arrangement 9 tilts the pelt board 3 to a horizontal position and place it in a support 11 as shown in FIG. 5. The gripping elements 7 are now moved away from each other by means of the actuator 8 so that the pelt board 3 is released and is now supported by the support 11 as shown in FIG. 6.

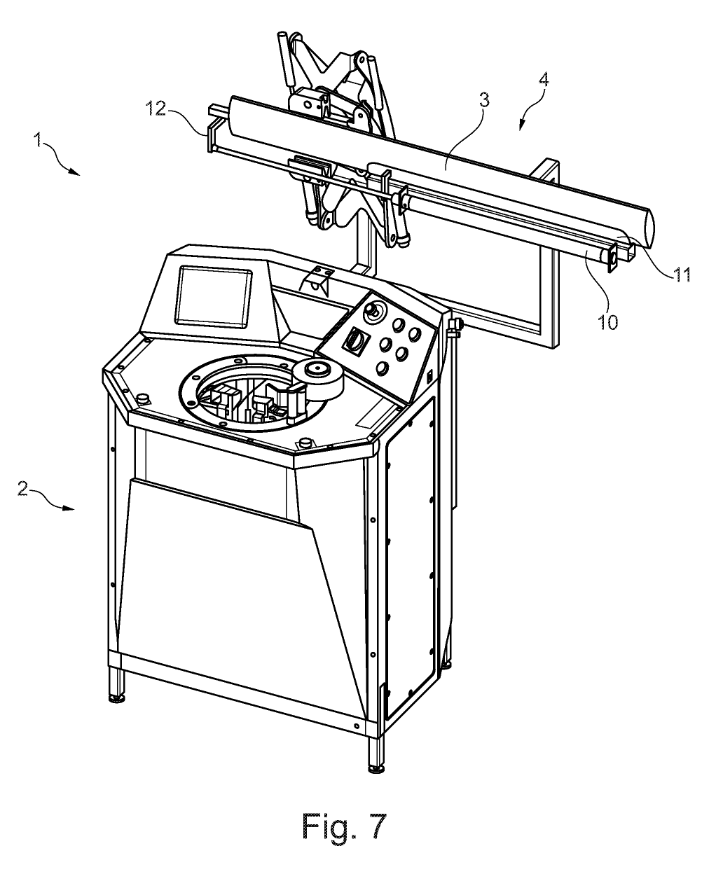

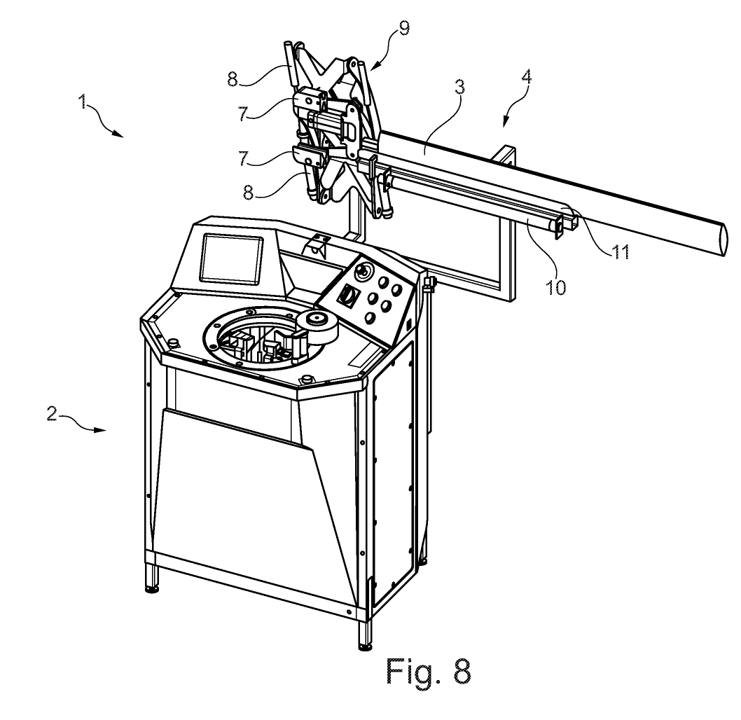

In order to remove the pelt board 3, the displacement arrangement 10 for the pelt board 3, which is a linear actuator, is activated as shown in FIG. 7, and a contact piece 12 engages the foot of the pelt board 3, where after the pelt board displacement arrangement 10 again is activated to displace the pelt board 3 in a horizontal direction as shown in FIG. 8 from which it may be pushed out from the support and e.g. onto a conveyor or for being further handled by another gripping arrangement, e.g. for being placed in a drying arrangement.

A similar procedure could be performed for the placing of a pelt board 3 in the machine 2 in order for the pelt on the pelt board 3 to be stretched and secured to the pelt board 3 by means of the machine 2.

A number of different embodiments could be envisioned by the skilled person within the present invention, including the automatic placement of the removed pelt board 3 in a drying manifold or in a transport system by means of the device 4. Also, the device could comprise two or more gripping arrangements 7, 8, one for removing a pelt board 3 from the machine 2 and another for simultaneous placing a new pelt board 3 with a pelt thereon in the machine 2 for stretching of the pelt and fastening it to the pelt board 3 by means of the machine 2.

### LIST OF REFERENCES

1 System of machine for stretching pelts on pelt board and device for placing or removing the pelt boards
2 Machine for stretching pelt on pelt boards
3 Pelt board
4 Device for placing pelt boards in the machine or for removing peltboards from the machine
5 Claws of the machine for gripping the pelt
6 Fastening means
7 Set of gripping elements
8 Actuator for gripping elements
9 Displacement arrangement for set of gripping elements and actuator
10 Displacement arrangement for pelt board supported by support
11 Support
12 Pelt board contact piece of displacement arrangement for pelt board

1. System comprising a machine for stretching pelts on pelt boards and a device for removing the pelt board from said machine, the device comprising
a gripping arrangement for gripping a pelt board in an operational position at the machine,
a displacement arrangement for displacing said gripping arrangement, and
a controller for controlling the operation of said gripping arrangement and said displacement arrangement, the controller being adapted to perform a removal of a pelt board including the steps of
a) control the displacement arrangement to position the gripping arrangement ready for gripping a pelt board in an operational position at the machine,
b) control the gripping arrangement to grip said pelt board,
c) control the displacement arrangement to move the gripping arrangement carrying the pelt board upwards and in a horizontal direction, and
d) control the gripping arrangement to release the pelt board.

2. System according to claim 1, wherein said horizontal movement of the gripping arrangement step c) includes a movement towards a back side of the machine opposite an operator's place in front of the machine.

3. System according to claim 1, wherein the controller is adapted to, between steps c) and d), perform the step of
c1) control the displacement arrangement to rotate the pelt board to a substantially horizontal position.

4. System according to claim 1, wherein the controller is further being adapted to perform a placing of a pelt board in the machine including the steps of
1) control the gripping arrangement to grip a pelt board ready for being processed by the machine,
2) control the displacement arrangement to move the gripping arrangement carrying the pelt board in a horizontal direction and downwards, so that the pelt board will be in an operational position in the machine, and
3) control the gripping arrangement to release the pelt board.

5. System according to claim 4, wherein said horizontal movement of the gripping arrangement in step 2) includes a movement towards an operator's place in front of the machine.

6. System according to claim 4, wherein the gripping arrangement comprises two sets of gripping elements and actuators for each set of gripping elements.

7. System according to claim 6, wherein one set of gripping elements are dedicated to placing a pelt board in said machine and the other set of gripping elements are dedicated to removing a pelt board from said machine.

8. Device for placing a pelt board in or removing a pelt board from a machine for stretching pelts on pelt boards, the device being suitable for constituting a part of a system according to claim 1.

9. Method for removing a pelt board from a machine for stretching pelts on pelt boards by means of a device comprising a gripping arrangement and a displacement arrangement for displacing said gripping arrangement, the method comprising the steps of
a) positioning the gripping arrangement by means of said displacement arrangement to be ready for gripping a pelt board in an operational position at the machine,
b) gripping said pelt board by means of the gripping arrangement,
c) moving the gripping arrangement by means of said displacement arrangement to carry the pelt board upwards and in a horizontal direction, and
d) releasing the pelt board from the gripping arrangement.

10. Method according to claim 9, wherein said horizontal movement of the gripping arrangement in step c) includes a movement towards a back side of the machine opposite an operator's place in front of the machine.

11. Method according to claim 9, which between steps c) and d) comprises the step of
c1) controlling the displacement arrangement to rotate the pelt board to a substantially horizontal position.

12. Method for placing a pelt board in an operational position at a machine for stretching pelts on pelt boards by means of a device comprising a gripping arrangement and a displacement arrangement for displacing said gripping arrangement, the method comprising the steps of
1) gripping a pelt board ready for being processed by the machine by means of the gripping arrangement,
2) moving the gripping arrangement by means of said displacement arrangement to carry the pelt board in a horizontal direction and downwards by means of the displacement arrangement, so that the pelt board is in an operational position in the machine, and
3) releasing the pelt board from the gripping arrangement.

13. Method according to claim 12, wherein said horizontal movement of the gripping arrangement in step 2) includes a movement towards an operator's place in front of the machine.
